(19) United States
(12) Patent Application Publication
(10) Pub. No.: US 2002/0060153 A1
(43) Pub. Date: May 23, 2002

(54) Microchannel turn design

(75) Inventor: Marc Elpel, Belmont, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: DNA Sciences, Inc.

(21) Appl. No.: 09/938,271

(22) Filed: Aug. 23, 2001

Related U.S. Application Data
(60) Provisional application No. 60/246,464, filed on Nov. 6, 2000.

(51) Int. Cl. G01N 27/26; G01N 27/447

(52) U.S. Cl. 204/451; 204/601

(57) ABSTRACT

A microcapillary channel having two opposite sides, wherein the opposite sides have different lengths over a straight portion of the channel.

A microchannel system for compensating for skewing of sample plugs as the sample plugs pass around a curved microchannel, comprising: a first microchannel having two opposite sides, wherein the opposite sides have different lengths over a straight portion of the first channel; a second microchannel having two opposite sides, wherein the opposite sides have different lengths over a straight portion of the second channel; and a curved portion of microchannel disposed between, and in fluid communication with, the first and second microchannels, wherein the second sides of the first and second microchannels are disposed towards the interior of the curvature of the curved portion.

### CROSS-REFERENCES TO RELATED APPLICATIONS

This application is a regular application of, and claims the benefit of priority from U.S. Provisional Patent Application No. 60/246,464 filed Nov. 6, 2000, the full disclosure of which is incorporated herein by reference.

### BACKGROUND OF THE INVENTION

The present invention relates to microcapilarry electrophoresis systems, and to channels microfabricated on electrophoretic separation plates.

The use of electrophoretic separation channels in microfabricated electrophoretic separation plates offers numerous benefits over existing gel separation technologies, and is expected to offer potential new benefits in the field of sequencing technology, among other fields.

As microfabricated electrophoretic separation plate and electrokinetic fluid flow designs continue to evolve, it has become desirable to fabricate these separation or fluid flow channels such that they have curved portions. This is especially true when fabricating long channels on relatively small microplate surfaces, or when designing patterns of microchannels on a microplate such that different channels have the same overall length, but take different paths across the surface of the microplate.

Unfortunately, difficulties occur when attempting to move a sample plug around a curved portion of an electrophoretic separation microchannel. Such problems specifically occur due to the fact that as the sample plug is advanced around a curved portion of a microchannel, its leading and trailing edges tend to become skewed in orientation relative to the walls of the microchannel. This is due to the fact that one side of the channel is shorter than the other side of the channel around the curved portion of the channel. Along the shorter side of the channel, (i.e.: the inward side of the curve), the electrostatic fields will tend be larger, thereby pulling the sample plug with a greater force than along the longer side of the channel, (i.e.: the exterior side of the curve). Accordingly, the leading edge of a sample plug will advance faster around the interior (i.e.: inward) side of the curved microchannel than around the exterior (i.e.: outward) side of the curved microchannel. Moreover, the quality of sequencing data has been shown to be best for long straight channels, as opposed to channels with curves.

In existing systems, the width of the curved portions of the microchannels have been reduced in an attempt to prevent excessive skewing of the sample plug moving therethrough. (By reducing the relative width of the channel, the difference in length between the opposite sides of the curved portion of the channel is minimized). In other words, the curved portions of the microchannels have been fabricated to be narrower than the straight portions of the microchannels as an attempted solution to the problem of the sample plugs skewing in orientation as they round a corner.

Unfortunately, by simply narrowing the curved portions of the microchannel channel to counteract such skewing effects, these channels become prone to blockage. As such, these microchannels can only typically be used a limited number of times before they must be discarded. In addition, such narrow corners define the parameters used to etch the plate. For instance, a 50 um turn would limit the etch to 25 um, whereas the desirable etch for the remainder plate may be closer to 50 um.

### BRIEF SUMMARY OF THE INVENTION

The present invention provides a novel microchannel design which advantageously permits a sample plug to be directed around a curved path (which may include a 90° or 180°turn, or any other angle of turn) while counteracting any skewing effects of the curve or turn in the microchannel.

In a preferred aspect, the present microchannel design comprises a microchannel having a portion of the channel which is widened to one side. This widening of the microchannel may be caused by bulging, tapering or flaring the microchannel outwardly to one side along a portion of the length of the microchannel. In other words, whereas one side of the microchannel is substantially straight along its length, the opposite side bulges, taper or flares outwardly (away from the first (i.e.: straight) side).

In various aspects, the present widened channel comprises a straight portion of the channel having a straight first side and a second side having two portions which are angled to the first side, and a portion which is parallel to the first side (with the portion which is parallel to the first side spanning between the two portions which are angled to the first side).

In one aspect of the invention, a pair of such microchannel designs (i.e.: microchannels having portions which widen outwardly to one side) are disposed on opposite ends of a curved microchannel portion. As will be explained, each of the present microchannel designs (i.e.: the microchannels having portions which widen outwardly to one side) will tend to cause the sample plug passing therethrough to skew in a first direction, whereas the sample plug will tend to skew in an opposite direction when passing around the curved portion of the microchannel.

In this aspect of the invention, each of the two widened portions are disposed projecting, tapering, bulging or flaring towards the interior of the curvature (i.e.: the inward side) of the curved portion.

Preferably, the combined skewing effects of the first and second widened microchannel portions will tend to skew the sample to the same amount that the curved portion of the microchannel skews the sample in the opposite direction. Stated another way, the first widened portion “pre-skews” the sample before it enters the curved portion of the microchannel and the second widened portion “post-skews” the sample after it leaves the curved portion of the microchannel. The combined effects of such “pre-skewing” and “post-skewing” will preferably compensate for the skewing of the sample plug caused by the sample moving around the curved portion of the microchannel. Accordingly, the present invention operates by skewing the sample plug in a direction opposite to that which the plug would naturally skew when passing around a turn or corner.

Stated another way, in various aspects of the present invention, a microchannel is fabricated with a curved portion having a straight portion attached to either end of the curved portion. Each of the straight portions have a portion or region which is widened such that the lengths of the opposite sides of the microchannel is approximately equal over the total combined length of the curved and two straight portions of the microchannel.

Advantageously, the present system provides a novel solution to the problems caused by moving sample plugs through curved microchannels, offering the additional benefits of minimal impact on plate loading, cleaning, and sequencing.

As such, the present system can be incorporated into microchannel designs such that long, curved microchannels can be fabricated in small microplates, with less sequencing degradation than in a non-compensated turn.

### BRIEF DESCRIPTION OF THE DRAWINGS

FIG. 1 is a top plan illustration of the present microcapillary design, showing a series of sample plugs passing therethrough.

FIG. 2 is a top plan illustration of a pair of widened channel portions positioned on opposite sides of a 90° turn in the microchannel.

FIG. 3 is a top plan illustration of a pair of widened channel portions positioned on opposite sides of a 180° turn in the microchannel.

### DETAILED DESCRIPTION OF THE INVENTION

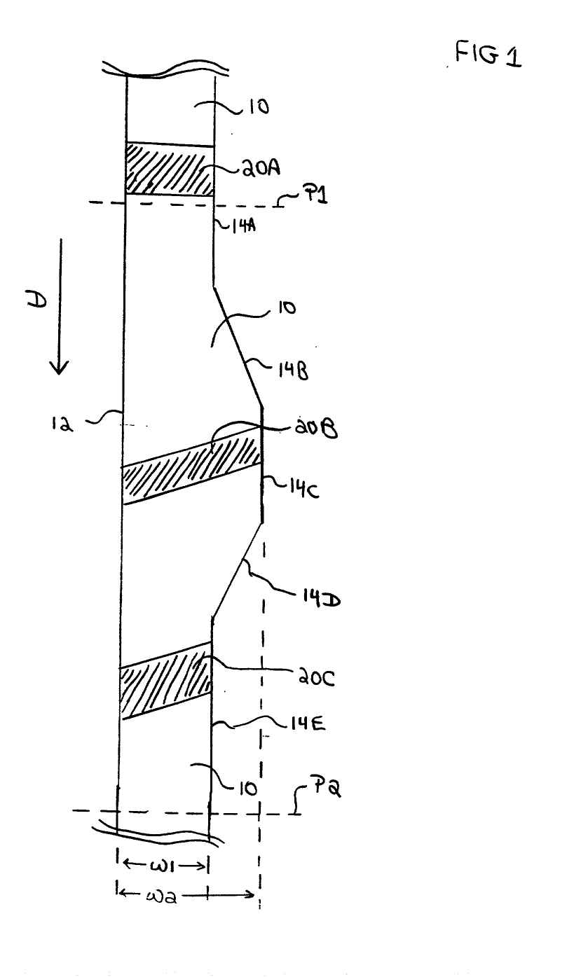

Referring to FIG. 1, a microchannel 10 is on the surface of a microplate. Microchannel 10 has a first side 12 and a second side 14. Side 12 is preferably straight, as shown. Side 14 is preferably composed of a plurality of sections 14A, 14B, 14C, 14D and 14E, as shown. In accordance with the present invention, side 14 bulges, flares, tapers or otherwise protrudes away from side 12 such that the total length of side 14 between points P1 and P2 is greater than the total length of side 12 between points P1 and P2.

In a preferred aspect, sections 14B and 14D are disposed at an angle to side 12 such that microchannel 10, protrudes, bulges, tapers or flares outwardly to one side, as shown. Accordingly, microchannel 10 comprises portions having both a narrow width W1 and a wide width W2, as shown.

In accordance with the present invention, a sample plug 20 is advanced along the length of microchannel 10 in direction D, as follows. Initially, the sample plug is disposed at the position shown as plug 20A. As the sample plug is advanced (electrophoretically or electrokinetically by an electrostatic field) in direction D, the edge of the plug adjacent side 12 will be experiencing a stronger electrostatic field, thereby causing this edge to move faster in direction D than along the opposite edge contacting side 14 of the channel.

As can also be seen, plug 20 will also tend to spread out slightly from the position shown as plug 20A to the position shown as plug 20B, as plug 20 passes from the narrow (W1 width) portion of the channel through the wider (W2 width) portion of the channel.

Eventually, the sample plug will reach the position shown as plug 20C, being skewed with respect to sides 12 and 14E of the microchannel.

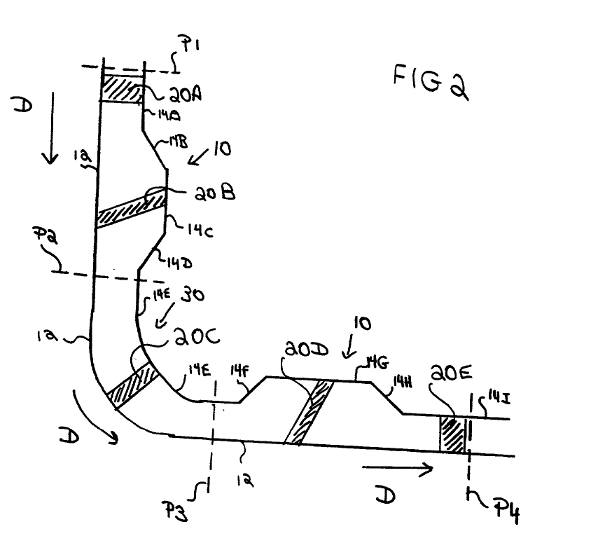

Referring to FIG. 2, a curved microchannel portion 30 can be positioned between two of microchannel portions 10. (i.e.: a first straight portion 10 is disposed between points P1 and P2; a curved portion 30 is disposed between points P2 and P3; and a second straight portion 10 is disposed between points P3 and P4).

As sample 20 moves from P1 to P2 (i.e.: from the position shown as 20A to plug 20B), the plug will tend to skew with the side of the plug adjacent side 12 of the microchamber advancing faster than the side of the plug adjacent side 14, as explained above and as illustrated in FIG. 1.

As plug 20 is then moved around curved portion 30, (i.e.: as plug 20C moves from P2 to P3), the plug will then tend to skew in an opposite direction since channel side segment 14E is shorter than the segment of side 12 between points P2 and P3.

As plug 20D is then moved from point P3 to P4, it will tend to be skewed in the same direction it was skewed while moving from point P1 to P2. In a preferred aspect of the invention, the combined skewing of the sample plug as it passes through both of channel portions 10 will be approximately equal to the amount of skewing caused by the sample plug moving through curved portion 30 of the system. Therefore, when sample plug 20 reaches the position shown as 20E, it will tend not to be skewed with respect to either of sides 12 or 14 of the channel.

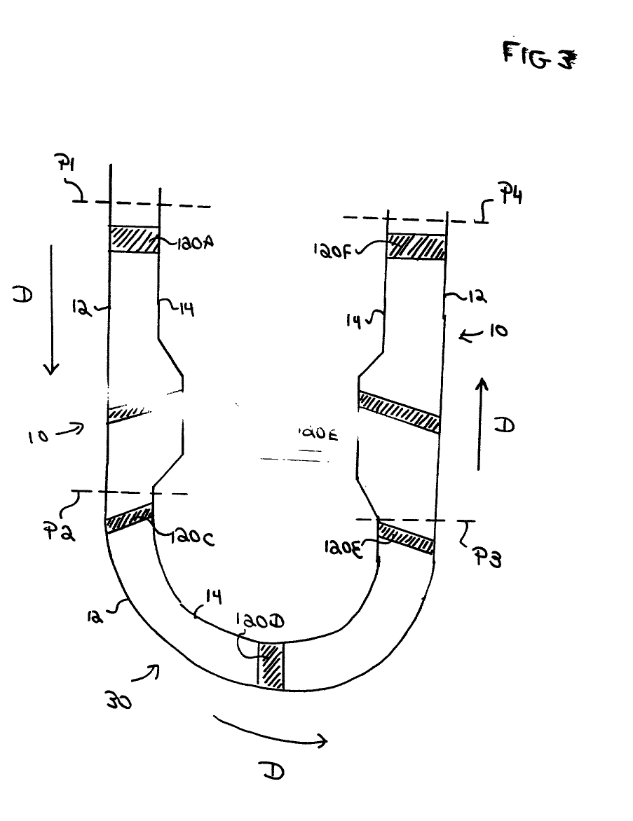

FIG. 3 illustrates a 180° turn system similar to that of FIG. 2, with the difference being that curved portion 30 is curved 180° (rather than 90° as shown in FIG. 2). As such curved portion 30 will tend to cause a greater amount of skewing of sample 120 between points P2 and P3 (ie: as the sample moves from 120C to 120D to 120E). Therefore, each of channel portions 10 preferably are dimensioned wider to cause more skewing of the sample (as compared to channel portions 10 in FIG. 2). Specifically, sides 14 located between P1 and P2 and between P3 and P4 are somewhat longer in FIG. 3 than in FIG. 2 (assuming sides 12 located between P1 and P2 and between P3 and P4 are the same length in FIGS. 2 and 3).

Returning to FIG. 1, the angles of sides 14B and 14E to side 12 and the ratio of the length of segment 14C to segments 14B/14E will be dependent upon factors such as the length, width and angle of curvature of the curved section of the microchannel. Accordingly, the present invention is not limited by the dimensions shown, which are provided solely for ease of illustration purposes. In particular, the angles of sides 14B and 14E to side 12 may be much less than those shown in the Figs.

Variations and modifications to the present invention are possible. For example, the bulge, taper, flare or protrusion which protrudes from one side of channel 10 (and is caused by side 14 being longer than side 12), need not comprise two angled portions 14A and 14D with a straight portion 14C disposed therebetween, but instead may take other shapes, including that of a gently rounded bulge.

As such, the present system provides a solution to turning in a channel on an etched plate with only minimal impact on plate loading, cleaning, and sequencing results by pre and post skewing the sample before and after it passes through the curved portion of the channel, thereby counteracting the natural skewing effects of such turns.

By flaring a channel to one side, the effective path length may be increased, thereby causing a sample plug to skew. Together the cumulative effect of skewings caused by expansions in straight portions of the channel cancels out the skewing (in an opposite direction) caused by the sample passing through the curved portion of the channel.

In another aspect, the present invention is used to skew the orientation of a sample plug, however, the sample plug is not directed around a curved portion of cannel to “unskew” it. Such an application may be desirable, for example, when the orientation of a detector is skewed with respect to the microchannel. In this way, the orientation of the plug may be skewed to match the orientation of the plug.

In yet another aspect of the invention, a plurality of microchannel portions having a widened portion extending to one side according to the present invention may be used in series, with each skewing a sample plug passing therethrough to a small amount. Thereafter, the sample plug may be unskewed by passage through a curved portion of the microchannel, as desired.

What is claimed is:

1. A microcapillary channel having two opposite sides, wherein the opposite sides have different lengths over a straight portion of the channel.

2. The microcapillary channel of claim 1, wherein the opposite sides comprise a first and a second side and wherein the first side is straight and wherein a portion of the second side projects outwardly away from the first side, thereby widening a portion of the channel.

3. The microcapillary channel of claim 2, wherein the portion of the second side which projects outwardly away from the first side comprises two portions which are angled to the first side and a portion which is parallel to the first side, the portion which is parallel to the first side spanning between the portions which are angled to the first side.

4. A microchannel having a wide portion and narrow portion, wherein the wide portion is defined by a bulge, taper or flare on one side of the microchannel.

5. A microchannel having a wide portion and narrow portion, and having a first side and a second side, wherein the first side remains substantially straight along the length of the microchannel and wherein the second side bulges, tapers or flares away from the first side over a portion of the length of the microchannel.

6. A microchannel system for compensating for skewing of sample plugs as the sample plugs pass around a curved microchannel, comprising:
a first microchannel having two opposite sides, wherein the opposite sides have different lengths over a straight portion of the first channel;
a second microchannel having two opposite sides, wherein the opposite sides have different lengths over a straight portion of the second channel; and
a curved portion of microchannel disposed between, and in fluid communication with, the first and second microchannels, wherein the second sides of the first and second microchannels are disposed towards the interior of the curvature of the curved portion.

7. The microchannel system of claim 6, wherein the curved portion of microchannel is curved by approximately 90°.

8. The microchannel system of claim 6, wherein the curved portion of microchannel is curved by approximately 180°.

9. The microchannel system of claim 6, wherein the opposite sides of the channel have approximately equal lengths over a channel length which includes both the first and second microchannels and the a curved portion of the channel.

10. A microchannel system for compensating for skewing of sample plugs as the sample plugs pass around a curved microchannel, comprising:
a curved portion of microchannel having first and second ends;
a first microchannel having a wide portion and narrow portion, wherein the wide portion is defined by a bulge, taper or flare on one side of the first microchannel, the first microchannel fluidly connected to the first end of the curved portion of microchannel;
a second microchannel having a wide portion and narrow portion, wherein the wide portion is defined by a bulge, taper or flare on one side of the second microchannel, the second microchannel fluidly connected to the second end of the curved portion of microchannel, wherein the bulged, tapered or flared side of the first and second microchannels are disposed towards the interior of the curvature of the curved portion.

11. The microchannel system of claim 10, wherein the opposite sides of the channel have approximately equal lengths over a channel length which includes both the first and second microchannels and the a curved portion of the channel.

12. A microcapillary channel having two opposite sides, wherein the opposite sides have approximately equal lengths over a channel length which includes a curved portion of the channel.

13. A method of moving a sample plug around a curve in a microcapillary microchannel while preventing the channel from becoming skewed relative to the opposite sides of the microchannel, comprising:
advancing the sample plug in a straight path through a straight portion of microchannel;
advancing the sample plug through a first widened portion of microchannel, wherein the first widened portion is defined by a bulge, taper, or flare disposed to one side of the microchannel;
advancing the sample plug around a curved portion of the microchannel; and
advancing the sample plug through a second widened portion of microchannel, wherein the second widened portion is defined by a bulge, taper or flare disposed to one side of the microchannel.

14. The method of claim 13, wherein the bulge, taper or flare disposed to one side of each of the widened portions of the microchannel are disposed on the towards the interior of the curvature of the curved portion.

15. A method of moving a sample plug around a curve in a microcapillary microchannel while preventing the plug from becoming skewed relative to the opposite sides of the microchannel, comprising:
skewing the sample plug by passing it through a first widened portion of microchannel, wherein the first widened portion is defined by a bulge, taper, or flare disposed to one side of the microchannel prior to passing the sample plug through a curved portion of the microchannel; and
skewing the sample plug by passing it through a second widened portion of microchannel, wherein the second widened portion is defined by a bulge, taper, or flare disposed to one side of the microchannel after passing the sample plug through a curved portion of the microchannel.

16. The method of claim 15, wherein,
the sample plug is skewed in a first direction when passing through each of the first and second widened portions of the microchannel, and wherein the sample plug is skewed in an opposite direction when passing through the curved portion of the microchannel.

17. The method of claim 16, wherein,
the amount to which the sample plug is skewed in a first direction when passing through each of the first and second widened portions of the microchannel is approximately equal to the amount to which the sample plug is skewed in an opposite direction when passing through the curved portion of the microchannel.

18. A method of moving a sample plug around a curve in a microcapillary microchannel while preventing the plug from becoming skewed relative to the opposite sides of the microchannel, comprising:
skewing the sample plug by passing it through at least one widened portion of microchannel, wherein the at least one widened portion is defined by a bulge, taper, or flare disposed to one side of the microchannel; and
passing the sample plug through at least one curved portion of the microchannel.

19. A method of moving a sample plug in a microcapillary microchannel while skewing the plug relative to the opposite sides of the microchannel, comprising:
passing the sample plug through at least one widened portion of microchannel, wherein the at least one widened portion is defined by a bulge, taper, or flare disposed to one side of the microchannel.
